(19) United States
(12) Patent Application Publication
(10) Pub. No.: US 2006/0081417 A1
(43) Pub. Date: Apr. 20, 2006

(54) Collapsible escape ladder

(75) Inventor: Forest W. Whitesel, Lewisberry, PA (US)

Correspondence Address: MCNEES, WALLACE & NURICK LLC, 100 PINE STREET, P.O. BOX 1166, HARRISBURG, PA, 17108-1166, US

(73) Assignee: REDDCO INC., Lewisberry, PA (US)

(21) Appl. No.: 10/967,058

(22) Filed: Oct. 15, 2004

(51) Int. Cl. E06C 9/00

(52) U.S. Cl. 182/84

(57) ABSTRACT

An escape ladder includes a first rail secured to a structure, a second rail and a plurality of rungs hingedly connected to the first rail and the second rail in a non-actuated condition. A latch secures the second rail and the plurality of rungs in a first position with respect to the first rail, in a non-actuated condition, the second rail and the plurality of rungs actuating to a second position with respect to the first rail upon the latch being moved to an actuated condition. A release device connected to the latch moves the latch from the non-actuated condition to the actuated condition. The release device has a horizontally extending portion that is accessible by an occupant in the structure, and that is accessible from the ground by an instrument configured to engage the horizontally extending portion to move the release device to the actuated condition.

### BACKGROUND OF THE INVENTION

The present invention relates generally to a ladder, and more specifically, the present invention relates to a collapsible escape ladder for egress from a structure.

Escape ladders are needed to provide an alternate path or passageway for egress from multiple level structures, especially in case of fire or other emergency when normal routes are inaccessible. Although elaborate platforms equipped with stairs can be constructed, such a construction is expensive. In addition, especially for multiple story residences, the large platform would typically be undesirable as it could detract from the appearance of the residence. Therefore, collapsible escape ladders are preferred.

For the escape ladder to be useful, it must be easily opened, either by the occupant from an upper level of the structure, or with commonly available instruments from the ground, such as those used by a fire fighter.

What is needed is an escape ladder construction that is simple to operate, and which can easily be opened by an occupant attempting to exit from the structure or from the ground with instruments commonly available to a fire fighter.

### SUMMARY OF THE INVENTION

The present invention is directed to an escape ladder including a first rail for securing to a structure, a second rail and a plurality of rungs hingedly connected to the first rail and the second rail. A latch is in a non-actuated condition for securing the second rail and the plurality of rungs in a first position with respect to the first rail, the second rail and the plurality of rungs moving to a second position with respect to the first rail upon the latch being moved to an actuated condition. A release device is connected to the latch to move the latch from the non-actuated condition to the actuated condition, the release device having a horizontally extending portion to move the release device to position the latch in the actuated condition.

The present invention further includes an escape ladder including a first rail to be secured to a structure and a plurality of adjustable brackets for securing the first rail to a structure. A second rail is disposed opposite the first rail and a plurality of rungs are hingedly connected to the first rail and the second rail. A latch is in a non-actuated condition for securing the second rail and the plurality of rungs in a first position with respect to the first rail, the second rail and the plurality of rungs moving to a second position with respect to the first rail upon the latch being moved to an actuated condition. A release device is connected to the latch to move the latch from the non-actuated condition to the actuated condition, the release device having a horizontally extending portion to move the release device to position the latch in the actuated condition.

One advantage of the present invention is that it can be secured in a vertical position to a structure using substantially identical brackets.

Another advantage of the present invention is that it can easily be opened by an occupant attempting egress from the structure or from the ground with instruments commonly available to a fire fighter.

A further advantage of the present invention is that it can be located for convenient access from either side of a structural opening.

A still further advantage of the present invention is that it is of modular construction.

Yet another advantage of the present invention is that it is extremely simple to operate.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a ladder of the present invention in a collapsed configuration.

FIG. 2 is a perspective view of the ladder of the present invention in an opened configuration.

FIG. 3 is an exploded partial perspective view of the ladder of the present invention.

FIG. 4 is a perspective view of an adjustable mounting bracket of the present invention.

FIG. 5 is an enlarged plan view of the adjustable mounting bracket of the present invention.

FIG. 6 is a perspective view of a reversible release device of the present invention.

FIG. 7 is a perspective view of the reversible release device of the present invention in a position reversed from that in FIG. 6.

FIG. 8 is an embodiment of the present invention having multiple release devices.

FIG. 9 shows both configurations of reversible release devices of the present invention.

Wherever possible, the same reference numbers will be used throughout the drawings to refer to the same or like parts.

### DETAILED DESCRIPTION OF THE INVENTION

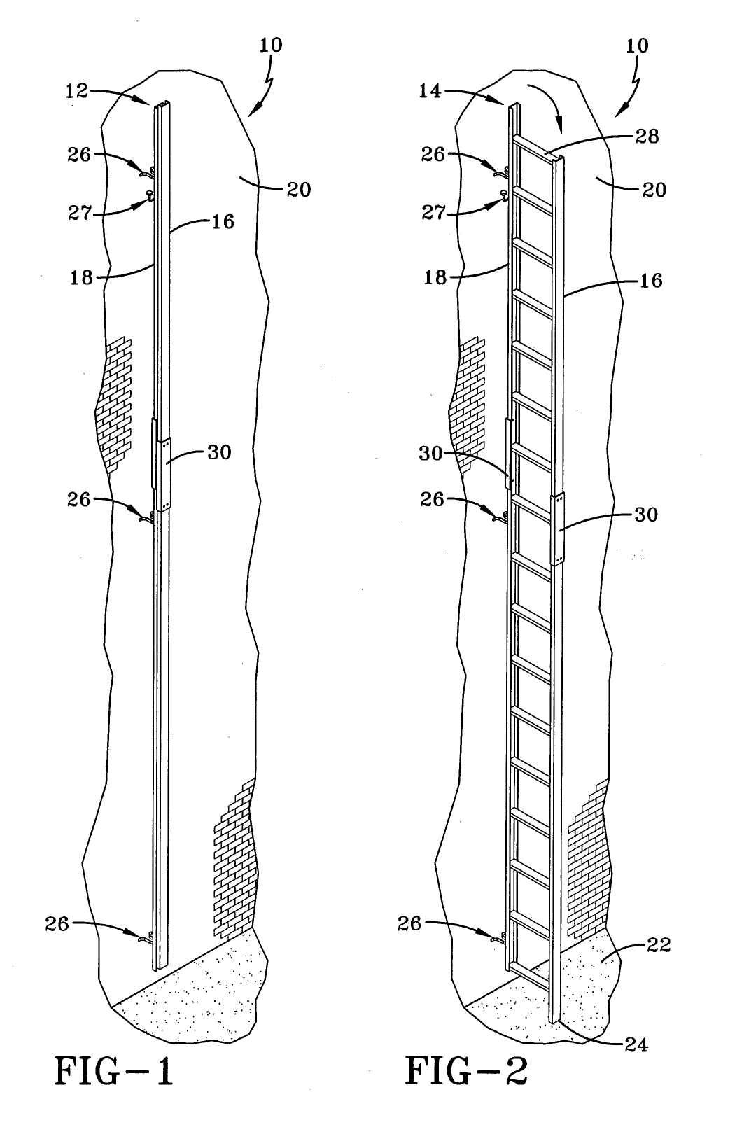

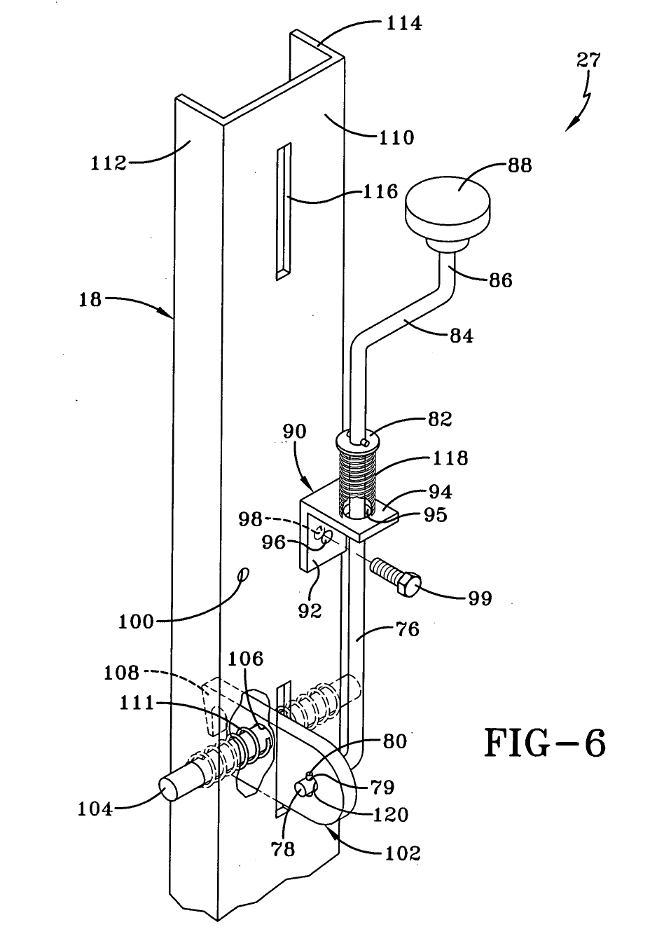

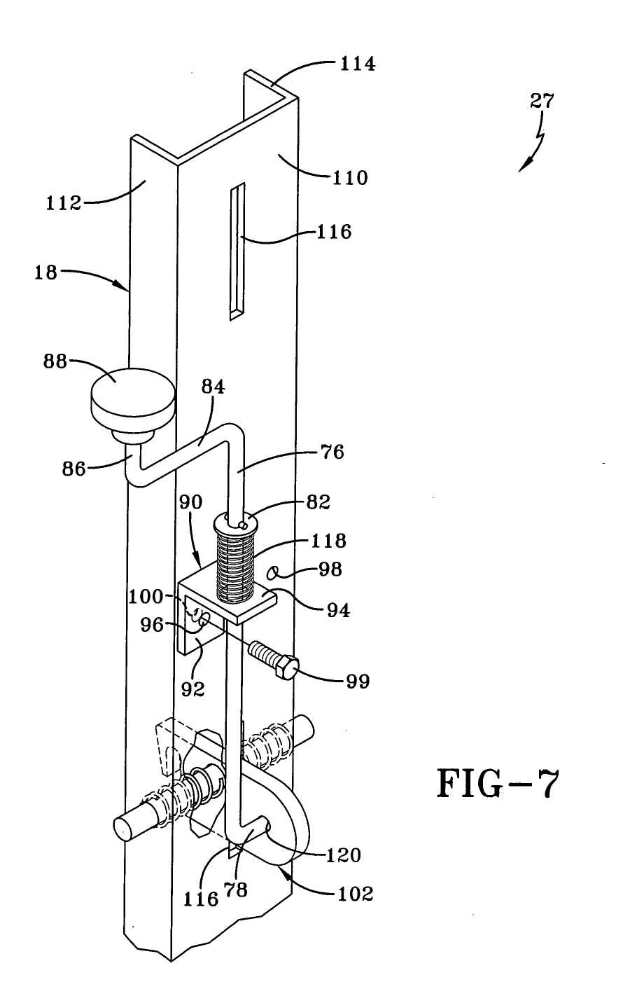

One embodiment of the collapsible escape ladder or fire escape 10 of the present invention is depicted in FIGS. 1 and 2. Fire escape 10 is shown in its closed or collapsed position 12 in FIG. 1 and in its open or extended position 14 in FIG. 2. Fire escape 10 includes a back or rear rail 18 that is connected to a structure 20 by a plurality of mounting brackets 26. A plurality of rungs 28 are hingedly connected between the back or rear rail 18 and a front rail 16. A latch 102 (FIG. 6) secures the fire escape 10 in its closed position 12 when the latch 102 is in a non-actuated or closed position. Upon actuating a reversible release device 27 to open the latch 102 or move the latch 102 to an actuated position, the front rail 16 and rungs 28 actuate or move preferably by virtue of gravity, away from the rear rail 18 to define the extended position 14. The extended position 14 is preferably achieved when an end 24 of the front rail 16 contacts the ground 22, or other substantially horizontally extending surface that provides a stable support platform. However, it is to be understood that the extended position 14 can be obtained without a portion of the front rail 16 contacting the ground or other horizontal surface. Once the fire escape 10 achieves the extended position 14, an occupant in the structure 20 can safely egress or exit from the structure 20 using the fire escape 10.

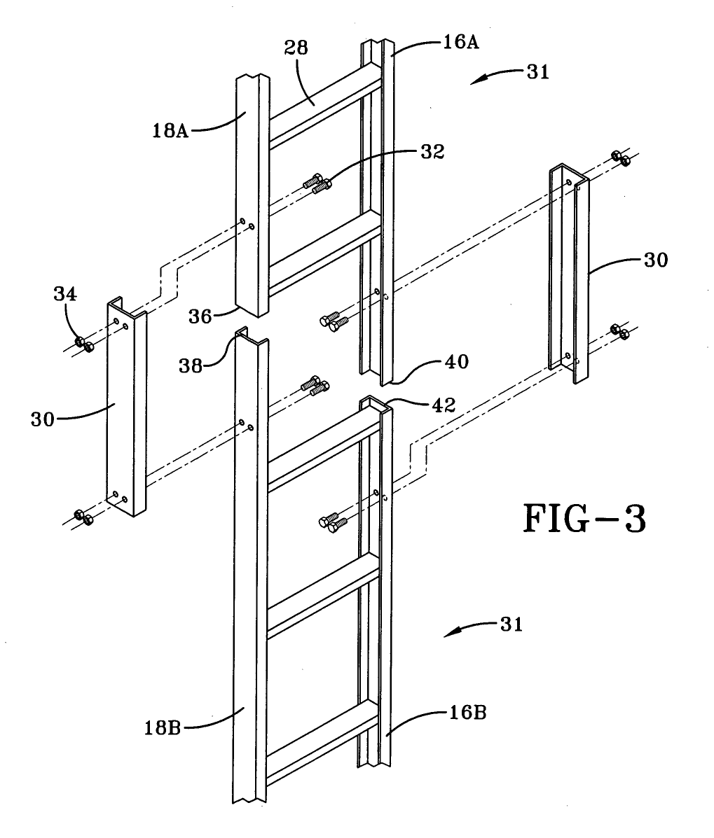

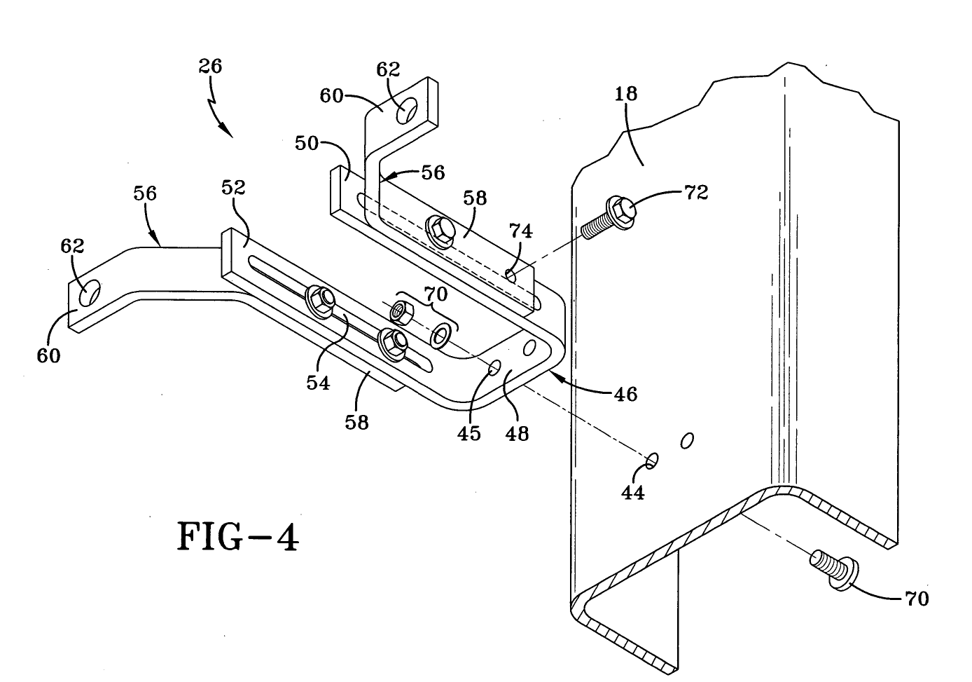

Referring to FIGS. 2-3, the rails 16, 18 of the fire escape 10 can be of unitary construction (FIG. 2), or each of the rails 16, 18 can be constructed of multiple (2 or more) rail segments. For example, FIG. 3 shows two rail segments as an upper rear rail 18A and a lower back rail 18B, and an upper front rail 16A and a lower front rail 16B. When multiple rail segments are used, a modular portion 31 can be constructed which, for example, includes one upper rear rail 18A, one upper front rail 16A and a plurality of rungs hingedly connected to the upper rear rail 18A and the upper front rail 16A. In a preferred embodiment, each of the modular portions 31 are identical and can be interconnected to form a fire escape 10 of a desired length. To interconnect modular portions 31, a coupling 30 can be used to secure an end 36 of the upper rear rail 18A adjacent to an end 38 of the lower rear rail 18 B by making use of fasteners, such as nuts 34 and bolts 32, or any other suitable connection technique or device. Similarly, another coupling 30 can be used to secure an end 40 of the upper front rail 16A adjacent to an end 42 of the lower front rail 16B by making use of fasteners, such as nuts 34 and bolts 32, or any other suitable connection technique or device. At least one advantage that is achieved by using modular portions 31 is that of significantly reduced piece size as compared to a fire escape having rails 16, 18 of unitary construction. Modular portions 31 of fire escape 10 are significantly less expensive to transport than unitary construction fire escapes, and in addition to transportation costs, the shipping size limitations for rails 16, 18 may preclude the possibility of unitary rail construction.

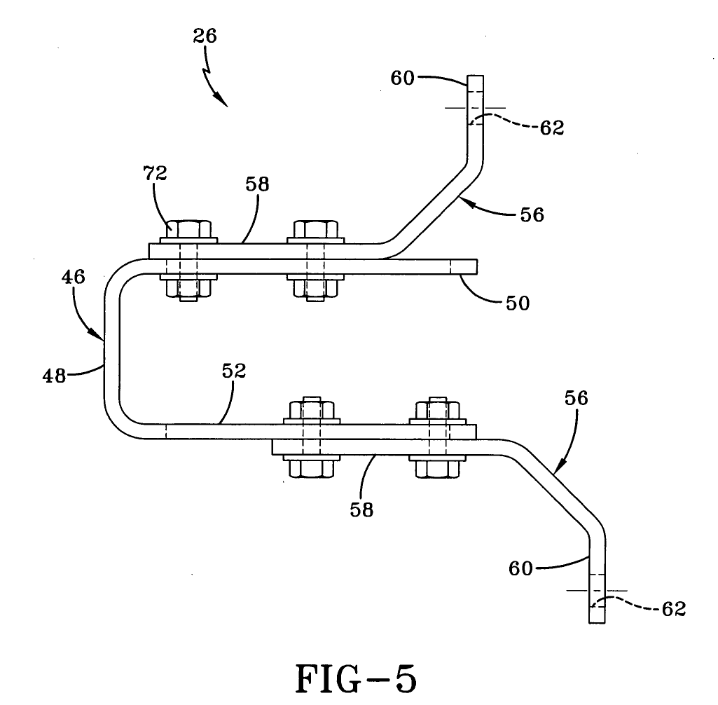

Referring to FIGS. 2 and 4-5, a plurality of adjustable brackets 26 are employed to secure the rear rail 18 to the structure 20. In a preferred embodiment, bracket 26 includes a C-shaped member 46 having a base 48 and a pair of legs 50, 52 extending substantially parallel to each other from opposite ends of the base 48. The base 48 is secured to the rear rail 16 by fasteners 70, such as nuts and bolts, that are received through the rear rail 18 and the base 48, for example, by respective apertures 44, 45. However, it is to be understood that any suitable connection technique or device can be used to connect the rear rail 18 and the base 48. Each leg 50, 52 include a slot 54 that extends along a significant portion of the length of leg 50, 52 to receive at least one, and preferably, a pair of fasteners 72 for securing an angle 56 to the corresponding leg 50, 52. Each angle 56 includes a base 58 having a number of apertures 74, such as two, each aperture 74 receiving a fastener 74. The base 58 extends to a flange 60, the flange 60 having an aperture 62 formed therein for receiving a fastener to secure flange 60 to the structure 20. By virtue of the slots 54 formed in legs 50, 52 of the C-shaped member 46, the position of the flange 60 of each angle 56 can be independently adjusted within a broad range of the base 48 as desired, such as shown in FIG. 5.

By possessing such a wide range of independent adjustment from base 48, a single construction of adjusting bracket 26 can be employed to secure the rear rail 18 of the fire escape 10 in a substantially vertical or plumb position. In other words, the adjusting bracket 26 accommodates for deviations in the structure 20 from a vertical coplanar surface, something a fixed bracket construction cannot accomplish without bending the fixed bracket and possibly compromising the strength of the fixed bracket. Thus, the adjusting brackets 26 can be secured at different positions along the outer surface of a structure that are offset from each other. For example, many residential structures contain a masonry foundation along a lower level, transitioning to a framed construction containing siding at a higher level. Frequently, the masonry surface defines a plane that is offset from a plane that is defined by the siding. Moreover, the flange 60 of each angle 56 can move independently of the other flange 60, which permits the flange 60 to accommodate irregularities occurring at a given location. This could occur in the previous example where the masonry foundation itself contains an offset that would require the mounting bracket 26 to be configured similar to that shown in FIG. 5.

Referring to FIGS. 6-8, a preferred embodiment of the release device 27 is now discussed. The release device 27 includes an actuator 76 that extends at one end to a crank 78, the crank 78 having an aperture 79 formed therein to receive a retainer 80, such as a roll pin, to retain the crank 78 in engagement with an aperture 120 of a latch 102. The other end of the actuator 76 extends to a horizontally extending shoulder 84 that further extends to a neck 86, which secures a knob 88. The knob 88 provides a convenient means for an occupant to actuate the release device 27, such as by applying a substantially vertical downward force, such as from about 1 to about 2 pounds, to the knob 88. Alternately, the vertical force can be applied to any portion of shoulder 84, and may be applied by pressing on shoulder 84 from above, as an occupant could do, or by a pulling action that could be performed by engaging the shoulder 84 with a fire fighter's hook. In addition to providing access by readily available fire fighter tools, the shoulder 84 provides convenience to the occupant attempting egress from a structure. By extending substantially horizontally from actuator 76, the shoulder 84 brings the knob 88 into more accessible reach to the occupant of the structure, such as from a window, especially if the occupant has a limited reach. The position of the knob 88 is intended to allow the occupant to access the knob 88 in the dark and in an emergency situation when the occupant may be panicked.

The latch 102 extends through a slot 116 formed in a web 110 of the rear rail 18, and includes a latching end 108 opposite aperture 120, and is rotatably carried by a pin 104 which extends through an aperture 106 in the latch 102, the pin 104 being secured in opposed legs 112, 114 of the rear rail 18. Preferably, a torsion member 111, such as a torsion spring, is associated with the pin 104, rear rail 18 and the latch 102 to urge the latch 102 into rotation about the pin 104 to achieve a non-actuated condition. The non-actuated condition, which is used when the rear rail 18 and the rungs 28 (FIG. 1) are in the collapsed or closed condition 12, takes place when the latching end 108 is brought into engagement with an object (not shown) on the front rail 16, such as a rivot that is secured through opposed legs on the front rail 16, which maintains the back rail 18 and the rungs 28 in the collapsed or closed condition 12 (FIG. 1). Actuation of the release device 27 in a downward direction, as described in additional detail below, urges the latch 102 to an actuated condition, which urges the latching end 108 into non-engagement with the object, and preferably, by virtue of gravity, permits the fire escape 10 to achieve the extended position 14 (FIG. 2). However, other latch configurations well known in the art can also be used.

The release device 27 is slidably secured to the rear rail 18 by passing the actuator 76 through an aperture 95 formed in a flange 94 of a guide 90. The guide 90 includes a base 92 having an aperture 96 formed therein that is aligned with an aperture 98 in the rear rail 18, the base 92 being secured to the rear rail 18 by a fastener 99. A resilient device 118, such as a spring, is interposed between the flange 94 and a retainer 82, such as a washer and a roll pin combination, that is secured to the actuator 76. A substantially vertical downward force applied to the knob 88 toward the crank 78 likewise urges the actuator 76 in a downward vertical direction. As the actuator 76 moves in the downward vertical direction, resilient device 118 is compressed between the retainer 82 and the flange 94. Upon removal of the downward vertical force from the knob 88, the compressed resilient device 118 exerts a force between the flange 94 and the retainer 82 to urge the release device 27 in an upward direction. By virtue of the connection between crank 78 and latch 102, urging the release device 27 in an upward direction likewise urges the latch 102 into rotational movement about pin 104 to return to the non-actuated condition of the latch 102.

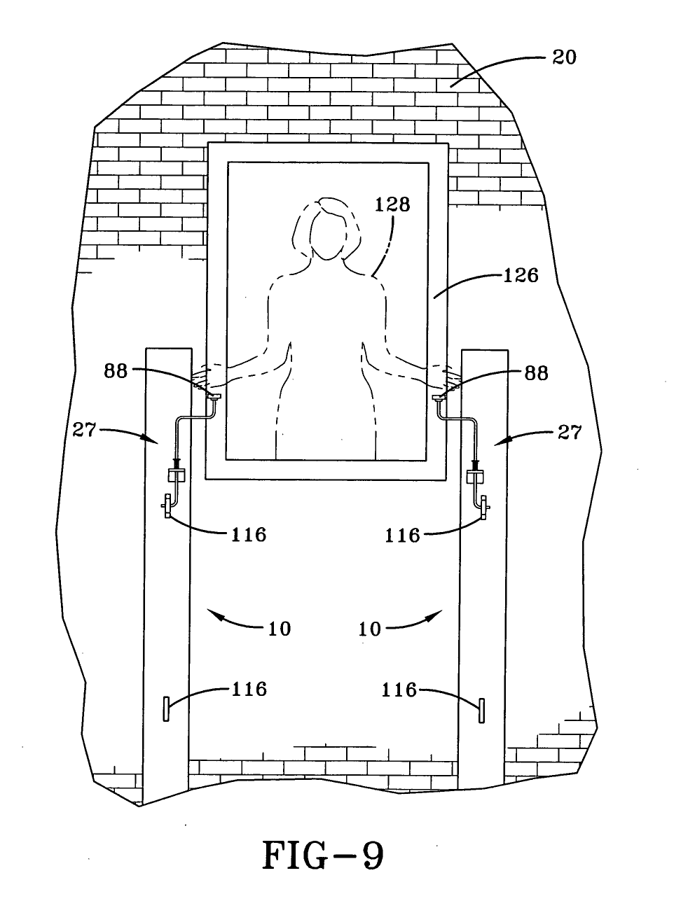

The release device 27 is reversible, as shown in comparison of FIG. 6 versus FIG. 7. In the reversed position, FIG. 7, the release device 27 is rotated approximately 180 degrees about the axis defined by the actuator 76. To engage aperture 120 of the latch 102, the crank 78 must be moved to the opposite side of the latch 102 than was used to access aperture 120 in FIG. 6. By shifting the release device 27 in FIG. 7 to access the latch 102 from the opposite side as in FIG. 6, the release device 27 mounting provisions must also be shifted. That is, although the flange 94 of guide 90 is still used to slidingly carry the actuator 76, the base 92 of guide 90 is secured to the rear rail 18 by fastener 99 which extends through aperture 96 of base 92 and an aperture 100 in the rear rail 18. The reversible feature permits the fire escape 10 to be positioned on either side of an opening in a structure, while providing convenient access to the knob 88. In other words, referring to FIG. 9, an occupant 128 positioned in a structure 20 and peering through an opening 126 in the structure 20, such as a window, and viewing the fire escape 10 of the present invention, the fire escape 10 configuration of FIG. 6 would be positioned to the occupant's right for convenient access to button 88 of the release device 27 with which to open the fire escape 10 to its extended position. Similarly, the fire escape 10 configuration of FIG. 7 would be positioned to the occupant's left for convenient access to button 88 of the release device 27 with which to open the fire escape 10 to its extended position.

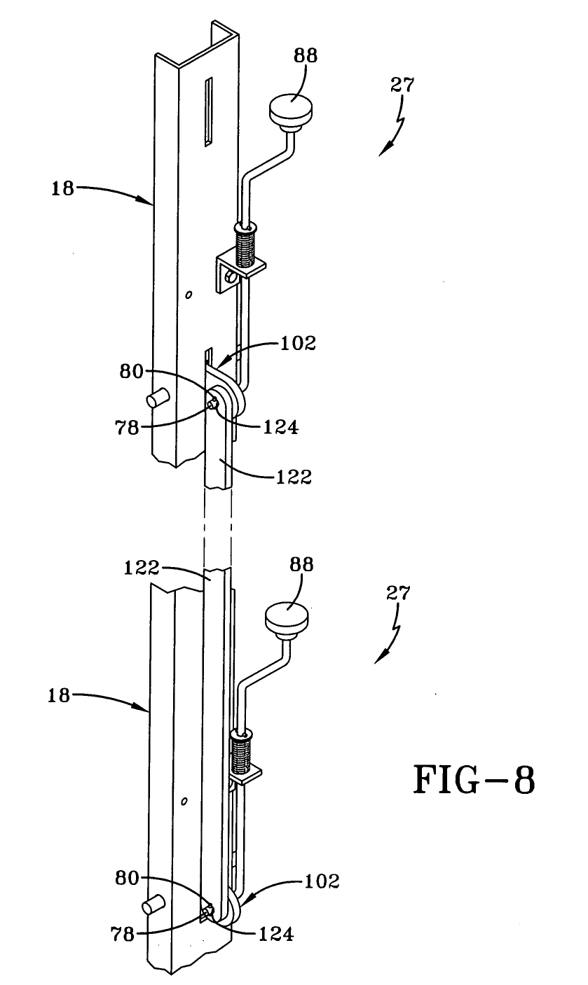

In an embodiment of the fire escape 10 (FIG. 8), a plurality of release devices 27 may be interconnected, such as by a connecting rod 122. Connecting rod 122 must be sufficiently rigid, or sufficiently supported to the rear rail 18 to become sufficiently rigid, so that applying a downward force to the knob 88 of the upper release device 27 applies the downward force to the crank 78 of the adjacent lower release device 27, sufficiently actuating the lower release device 27 to actuate the latch 102 to the actuated condition. Similarly, the connecting rod 122 must also have sufficient tensile strength so that upon applying a downward vertical force to knob 88 of the lower release device 27, the connecting rod 122 applies a downward vertical force to the crank 78 of the upper release device 27 sufficient to actuate the latch 102 to the actuated condition. This embodiment permits multiple access points from the fire escape 10, if available, and provides the option of ground access to actuate the fire escape 10 to its extended position without requiring a fire fighter's hook. If multiple release devices are used, it may not be required that each latch 102 function as described above, to avoid possible problems associated with having to simultaneously actuate multiple latches 102 to the actuated condition.

It is to be understood that if multiple release devices are used, such as with one or more connecting rods 122, they can be configured in any combination of configurations, that is reversed versus non-reversed, as described above. In a reversed configuration, each end of the connecting rod 122 is installed to a side of the latch 102 required for each release device 27. Additionally, it is also to be understood that a plurality of slots and corresponding apertures in back rail 16, such as slots 116 and apertures 98, 100 as shown in FIG. 6, so that the release devices can be positioned in any of multiple positions along back rail 18 as desired. Further, it is contemplated that similar slot 116 and apertures 98, 100 can be formed in both front and rear rails 16, 18 so that a single configuration of rail stock can be used to manufacture both front and rear rails 16, 18.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An escape ladder comprising:
a first rail to be secured to a structure;
a second rail disposed opposite the first rail;
a plurality of rungs hingedly connected between the first rail and the second rail;
a latch, the latch being in a non-actuated condition for securing the second rail and the plurality of rungs in a first position with respect to the first rail, the second rail and the plurality of rungs moving to a second position with respect to the first rail upon the latch being moved to an actuated condition;
a release device connected to the latch to move the latch from the non-actuated condition to the actuated condition, the release device having a horizontally extending portion to move the release device to position the latch in the actuated condition.

2. The escape ladder of claim 1 further comprises a modular segment comprising:
a third rail, a fourth rail and a plurality of rungs hingedly connected between the third rail and the fourth rail, wherein the third rail is secured to the first rail and the fourth rail is secured to the second rail.

3. The escape ladder of claim 2 wherein a coupling is used to secure each of the third rail to the first rail and the fourth rail to the second rail.

4. The escape ladder of claim 1 wherein the release device is reversible.

5. The escape ladder of claim 1 further comprising a plurality of adjustable brackets for securing the first rail in a substantially vertical position to the structure.

6. The escape ladder of claim 5 wherein each of the plurality of brackets is substantially identical.

7. The escape ladder of claim 6 wherein a first surface of the structure that is secured to a first adjustable bracket of the plurality of adjustable brackets is not coplanar with a second surface of the structure that is secured to a second adjustable bracket of the plurality of adjustable brackets.

8. The escape ladder of claim 7 wherein each adjustable bracket of the plurality of adjustable brackets is secured to the structure at least two positions.

9. The escape ladder of claim 8 wherein for at least one adjustable bracket of the plurality of adjustable brackets, each position of the at least two positions of the structure to which one adjustable bracket of the plurality of adjustable brackets is secured is not coplanar.

10. The escape ladder of claim 1 that is accessible by an occupant in the structure adjacent to the release device and from the ground by an instrument configured to engage the horizontally extending portion.

11. The escape ladder of claim 10 further comprising a plurality of interconnected release devices.

12. The escape ladder of claim 10 wherein the ground access is by a fire fighter's hook.

13. An escape ladder comprising:
a first rail to be secured to a structure;
a plurality of adjustable brackets, the plurality of brackets being configured to secure the first rail to a structure;
a second rail disposed opposite the first rail;
a plurality of rungs hingedly connected to the first rail and the second rail;
a latch, the latch being in a non-actuated condition for securing the second rail and the plurality of rungs in a first position with respect to the first rail, the second rail and the plurality of rungs moving to a second position with respect to the first rail upon the latch being moved to an actuated condition;
a release device connected to the latch to move the latch from the non-actuated condition to the actuated condition, the release device having a horizontally extending portion to move the release device to the actuated condition.

14. The escape ladder of claim 13 wherein the release device is accessible by an occupant in the structure adjacent to the release device and from the ground by an instrument configured to engage the horizontally extending portion.

15. The escape ladder of claim 14 wherein the ground access is by a fire fighter's hook.

16. The escape ladder of claim 13 wherein the plurality of adjustable brackets secures the first rail substantially vertical.

17. The escape ladder of claim 16 wherein each of the plurality of adjustable brackets is substantially identical.

18. The escape ladder of claim 17 wherein a first surface of the structure that is secured to a first adjustable bracket of the plurality of adjustable brackets is not coplanar with a second surface of the structure that is secured to a second adjustable bracket of the plurality of adjustable brackets.

19. The escape ladder of claim 18 wherein each adjustable bracket of the plurality of adjustable brackets is secured to the structure at least two positions.

20. The escape ladder of claim 19 wherein for at least one adjustable bracket of the plurality of adjustable brackets, each position of the at least two positions of the structure to which one adjustable bracket of the plurality of adjustable brackets is secured is not coplanar.
